(19) United States
(12) Patent Application Publication
(10) Pub. No.: US 2007/0118368 A1
(43) Pub. Date: May 24, 2007

(54) Audio encoding apparatus and audio encoding method

(75) Inventors: Masanao Suzuki, Kawasaki (JP); Yoshiteru Tsuchinaga, Fukuoka (JP); Miyuki Shirakawa, Fukuoka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 11/654,679

(22) Filed: Jan. 18, 2007

Related U.S. Application Data
(63) Continuation of application No. PCT/JP04/10416, filed on Jul. 22, 2004.

(51) Int. Cl. G10L 19/12

(52) U.S. Cl. 704/221

(57) ABSTRACT

An audio encoding apparatus comprising: a power calculation unit that calculates a power fluctuation ratio based on the input signal; a calculation unit that calculates a prediction gain fluctuation ratio based on the input signal; and a block length judging unit that selects one of encoding using a long block mode segmenting an input signal into frames each consisting of a predetermined number of samples and encoding each of the frames, and encoding using a short block mode segmenting each of the frames into short blocks and encoding each of the short blocks, based on the power fluctuation ratio and the prediction gain fluctuation ratio.

### CROSS-REFERENCE TO RELATED APPLICATION

This is a continuation of Application PCT/JP2004/010416, filed on Jul. 22, 2004, now pending, the contents of which are herein wholly incorporated by reference.

### BACKGROUND OF THE INVENTION

1. Field of the Invention

The present invention relates to an audio encoding apparatus and an audio encoding method of encoding an audio signal.

2. Description of the Related Art

Over the recent years, communication fields such as the Internet and satellite broadcasting have rapidly spread. Further, AV (Audio Visual) devices such as a DVD have also spread. With the spread thereof, there is increasingly a demand for audio encoding that efficiently compresses the audio signals. A mainstream type of audio encoding apparatus in recent years is an adaptive transform audio encoding apparatus that utilizes an auditory sense characteristic of the human being. A basic encoding process of the adaptive transform audio encoding apparatus is as follows.

In this encoding process, the audio signal in a time domain is transformed into a frequency domain. Then, the signal on the axis of frequency is segmented by a frequency band corresponding to a frequency resolution of the auditory sense. Subsequently, an optimum information quantity needed for encoding in each frequency band is calculated by utilizing the auditory sense characteristic of the human being.

Then, the signal on the axis of frequency is quantized based on the information quantity allocated to each frequency band. The adaptive transform audio encoding apparatus includes an MPEG (Moving Picture Experts Group)-2 AAC (Advanced Audio Coding) system standardized by ISO/IEC (International Organization for Standardization/International Electrotechnical Commission). This system is adopted also in BS digital broadcasting. This system has been focused over the recent years as the audio encoding apparatus capable of actualizing a high sound quality at a low bit rate.

(First Prior Art)

FIG. 10 is a configuration diagram showing a configuration of an MPEG-2 AAC encoder. A technology shown in FIG. 10 will hereinafter be referred to as a first prior art. The AAC encoder is described in detail in, for example, the following Non-Patent document 1.

The AAC encoder segments input signals into frames each consisting of a predetermined number of samples (sample count). Then, the AAC encoder executes an encoding process on a frame-by-frame basis. A frame length in the AAC system is classified into two types such as a long block (1024 samples) and a short block (128 samples). Herein, one frame is equal in length to one long block. The following discussion deals with a processing procedure of the AAC encoder illustrated in FIG. 10.

(1) To begin with, the input signals are inputted to afram eassembling unit 1001. The frame assembling unit 1001 segments the input signals into the frames (long blocks) each consisting of a predetermined number of samples). Signals outputted from the frame assembling unit 1001 are inputted to a modified discrete cosine transform unit (which will hereinafter be simply abbreviated to an MDCT transformunit) 1002 for the long block and to an MDCT transform unit 1003 for the short block.

The MDCT transform unit 1002 for the long block executes 1024-point MDCT transform about the inputted signals. Then, the MDCT transform unit 1002 for the long block calculates an MDCT coefficient (MDCT1). Further, the MDCT transform unit 1003 for the short block executes 128-point MDCT transform about the inputted signals. Then, the MDCT transform unit 1003 for the short block calculates an MDCT coefficient (MDCT2). Note that eight pieces of short blocks are provided per frame, and hence an 8-tuple MDCT2 is generated.

(2) Next, the frame assembling unit 1001 outputs the segmented input signals to a psychological auditory sense analyzing unit 1004 for the long block. Then, the psychological auditory sense analyzingunit 1004 for the long block obtains, from the input signals, a masking threshold value Th1 for the long block and a psychological auditory sense entropy PE1 for the long block. Herein, known methods disclosed in the paragraph of the Psychological Auditory Sense Model in the Non-Patent document 1 are exemplified as a Th1 calculation method and a PE1 calculation method. Similarly, the frame assembling unit 1001 outputs the input signals segmented into the frames to a psychological auditory sense analyzing unit 1005 for the short block. Then, the psychological auditory sense analyzing unit 1005 for the short block obtains, from the input signals, a masking threshold value Th2 for the short block and a psychological auditory sense entropy PE2 for the short block.

Herein, the term “psychological auditory sense entropy” connotes an information quantity representing a bit count required at the minimum for quantizing the signal. Further, the term “masking” represents such a phenomenon that a human being, if an error caused when a quantization unit quantizes the signal is equal to or smaller than a certain reference value, is unable to percept this error. Further, the reference value representing a limit of the error imperceptible to the human being is called a masking threshold value.

(3) Inputted to a block length judging unit 1006 are PE1 and Th1 acquired from the long block and PE2 and Th2 acquired from the short block. The block length judging unit 1006 judges which block, the long block or the short block, the quantization should be conducted based on.

Generally, it is desirable that a steady signal exhibiting almost no change in property is quantized based on the long block. If the signal of which an amplitude abruptly changes within the block is quantized based on the long block, there occurs a noise called a pre-echo not appeared in the input signal. The occurrence of this noise causes deterioration of the sound quality. FIG. 11 shows schematic graphs of an example of the pre-echo. FIG. 11(a) is the graph schematically showing the input signal before being encoded, and FIG. 11(b) is the graph showing a decoding sound when encoding by use of only the long block. A noise not appeared in the input signal occurs at a head area anterior to an attack sound.

This noise is called the pre-echo. The pre-echo can be obviated by decreasing a quantization block length. Therefore, in the AAC system, the block length judging unit 1006 judges the property of the input signal. Then, the block length judging unit 1006 judges the block length optimum to the quantization. To be specific, the block length judging unit 1006 selects the long block when PE1>PE1_-thr and selects the short block in other cases. Herein, PE1_thr is a predetermined threshold value (a constant).

(4) A judgment result of the block length judging unit 1006 is outputted to a selector 1007 that selects the MDCT. Further, the masking threshold value selected by the block length judging unit 1006 is outputted toaspectral quantization unit 1008. Namely, if the block length judging unit 1006 selects the long block, MDCT1 and Th1 are inputted to the spectral quantization unit 1008. Further, if the block length judging unit 1006 selects the short block, MDCT2 and Th2 are inputted to the spectral quantization unit 1008.

(5) The spectral quantization unit 1008 quantizes the MDCT coefficient for every frequency band in accordance with the inputted masking threshold value. Then, the spectral quantization unit 1008 output a quantization code 1

(6) The quantization code 1 outputted from the spectral quantization unit 1008 is inputted to a Huffman coding unit 1009. The Huffman coding unit 1009 transforms the quantization code 1 into a quantization code 2 of which redundancy is removed much further than the quantization code 1.

(7) the quantization code 2 is outputted from the Huffman coding unit 1009 to a quantization control unit 1011. Then, the quantization control unit 1011 calculates a total bit count of a bitstream to be finally outputted from the inputted quantization code 2. Note that a range encompassed by a dotted line in FIG. 10 represents a controllable range of the quantization control unit 1011.

(8) The quantization control unit 1011, if the calculated total bit count is greater than a bit count allowable to the present block, controls the spectral quantization unit 1008 and the Huffman coding unit 1009 to repeat the processes (5) through

(7). Further, the quantization control unit 1011, if the calculated total bit count is smaller than the bit count allowable to the present block, controls the Huffman coding unit 1009 to output the quantization code 2 to a bitstream generation unit 1010. Then, the quantization control unit 1011 controls the bitstream generation unit 1010 to output the bitstream.

Herein, the quantization process of the AAC system will be explained.

(a) The AAC system sets an exponent part of the MDCT spectrum to an initial value.

(b) The AAC system transforms the MDCT spectrum into a mantissa part and the exponent part. Namely, the AAC system transforms the MDCT spectrum into floating-point representation. Then, the AAC system quantizes the mantissa part (MDCT quantization).

(c) The AAC system obtains a bit count (a total bit count) needed when Huffman-coding the mantissa part and the exponent part that are quantized in (b).

(d) The AAC system finishes the quantization if the total bit count obtained in (c) is equal to or smaller than a quantization bit count (an allowable bit count) allowed to the present frame. The AAC system, if the total bit count is equal to larger than the allowable bit count, judges that the exponent part set in (a) is improper. Then, the AAC system changes the exponent part and repeats the processes of (b) trough (d). Subsequently, the AAC system determines such an exponent part that the total bit count is equal to or smaller than the allowable bit count.

Namely, the AAC system at first temporarily fixes the exponent part. Then, the AAC system determines the mantissa part and quantizes the MDCT spectrum. Subsequently, the AAC system obtains such a total bit count that a quantization error caused when transforming the MDCT spectrum into the exponent part and the mantissa part is equal to or smaller than an allowable error. Subsequently, the AAC system makes, if the total bit count is larger than the preset bit rate, the judgment of its being improper. Then, the AAC system changes the exponent part, and again executes the fixing process of the exponent part and the quantization process of the mantissa part of the MDCT spectrum. Subsequently, the AAC system determines such an optimum exponent part and an optimum mantissa part that the quantization error is equal to or less than the allowable error and that the total bit count is equal to or less than the set bit rate.

As described above, the AAC system, after performing the quantization and the Huffman coding, calculates the total bit count required. Then, the AAC system determines such an optimum exponent part and an optimum mantissa part that the total bit count is equal to or smaller than the allowable bit count allowed to the present frame. Herein, “optimum” implies that “the quantization error is equal to or less than the allowable error”.

As explained above, the first prior art is that the optimum block length is selected from the long block and from the short block. Hence, the first prior art is capable of obtaining the preferable sound quality with the lesspre-echo. The first prior art, however, involves performing the MDCT transform and the psychological auditory sense analysis for the long block and for the short block, respectively. Therefore, the first prior art requires a large throughput.

(Second Prior Art)

A method of determining the block length earlier by checking the property of the input signal before the MDCT transform and the psychological auditory sense analysis, is known as a method of solving the problem inherent in the first prior art described above. A method disclosed in, e.g., the following Patent document 1 is exemplified as a method of checking the property of the input signal. This method is a known method.

The method disclosed in the Patent document 1 is referred to as a second prior art. Then, FIG. 12 illustrates a configuration of this method. FIG. 12 is a configuration diagram showing the configuration of the second prior art. In the second prior art, one frame is segmented into much shorter blocks.

(1) To start with, the input signals are inputted to a frame assembling unit 1201. The frame assembling unit 1201 segments the input signals into the frames (the long blocks) each consisting of a predetermined number of samples. The signals outputted from the frame assembling unit 1201 are outputted to a power calculation unit 1202, a selector 1204 and a psychological auditory sense analyzing unit 1208.

The power calculation unit 1202 calculates power and a power fluctuation ratio from the inputted signals. The power calculation unit 1202 outputs the calculated power fluctuation ratio to a block length judging unit 1203.

The block length judging unit 1203 judges, based on the inputted power fluctuation ratio, which block, the long block or the short block, is used. Then, the block length judging unit 1203 outputs a judgment result thereof to a selector 1204 and a selector 1207. Based on the judgment result of the block length judging unit 1203, the selector 1204 and the selector 1207 select which block, the long block or the short block, is used.

An MDCT transform unit 1205 for the long block conducts 1024-point MDCT transform with respect to the inputted signal. Then, the MDCT transform unit 1205 for the long block calculates an MDCT coefficient (MDCT1).

Further, an MDCT transform unit 1206 for the short block executes 128-point MDCT transform with respect to the inputted signal. Then, the MDCT transform unit 1206 for the short block calculates an MDCT coefficient (MDCT2). Note that eight pieces of short blocks are provided per frame, and hence an 8-tuple MDCT2 is generated.

(2) Next, the psychological auditory sense analyzing unit 1208 obtains the masking threshold value from the input signal. Then, the masking threshold value obtained from the input signal is inputted to a spectral quantization unit 1209.

(3) The spectral quantization unit 1209 quantizes the MDCT coefficient for every frequency band in accordance with the inputted masking threshold value. Then, the spectral quantization unit 1209 outputs a quantization code 1 into which the MDCT coefficient is quantized.

(4) The quantization code 1 outputted from the spectral quantization unit 1209 is inputted to a Huffman coding unit 1210. The Huffman coding unit 1210 transforms the quantization code 1 into a quantization code of which the redundancy is removed much further than the quantization code 1.

(5) This quantization code 2 is inputted to a quantization control unit 1212. The quantization control unit 1212 calculates a total count of bit streams outputted finally on the basis of the inputted quantization code 2. Note that a range encompassed by a dotted line in FIG. 12 represents a controllable range of the quantization control unit 1212.

(6) The quantization control unit 1212, if the calculated total bit count is larger than the bit count allowed to the present block, controls the spectral quantization unit 1209 and the Huffman coding unit 1210 to repeat the processes (3) through (5). Further, the quantization control unit 1212, if the calculated total bit count is smaller than the bit count allowed to the present block, controls the Huffman coding unit 1210 to output the quantization code 2 to a bitstream generation unit 1211. Then, the quantization control unit 1212 controls the bitstream generation unit 1211 to output the bitstream.

FIG. 13 is a conceptual diagram showing an example of segmenting the frame into the short blocks in the second prior art. FIG. 13 shows a case of segmenting one frame into four pieces of short blocks. In the second prior art, input signal powers P(1), P(2), P(3), P(4) of the respective short blocks are obtained. Then, in the second prior art, power fluctuation ratios Δ_{P} (1, 2), Δ_{P} (2, 3), Δ_{P} (3, 4) between the neighboring short blocks are acquired. Herein, Δ_{P} (i, j) is defined as a power fluctuation ratio between a short block i and a short block j. The power fluctuation ratio Δ_{P} (i, j) is obtained in the following formula.

$${Δ}_{P} ( i , j ) = \frac{P ( j )}{P ( i )} \qquad [ Formula 1 ]$$

The power fluctuation ratio increases when the input signal abruptly augments. Conversely, the power fluctuation ratio decreases when the input signal abruptly diminishes. Accordingly, if there is almost no change in the power fluctuation ratio, the block length judging unit 1203 selects the long block. Further, the block length judging unit 1203 selects the short block if the power fluctuation ratio abruptly increases and decreases. This process enables the second prior art to select an optimum window length.

Moreover, in the second prior art, the block length is determined before the MDCT transform and the psychological auditory sense analysis. Therefore, in the second prior art, the MDCT transform and the psychological auditory sense analysis are executed with respect to only one of the long block and the short block. Hence, the second prior art is capable of encoding the audio signal with a less throughput than by the first prior art.

If the property of the input signal changes even when the power fluctuation ratio does not change, however, there might be a case in which the second prior art is incapable of detecting the change in the property of the input signal. For instance, with a sine wave being an input, if a frequency of the sine wave changes while the power is kept constant, the second prior art is incapable of detecting a signal change point by the method using only the power fluctuation ratio.

Herein, examples of the input signal, the power fluctuation ratio and a prediction gain fluctuation ratio will be explained with reference to FIG. 14. FIG. 14 shows graphs of the examples of the input signal, the power fluctuation ratio and the prediction gain fluctuation ratio. FIG. 14(a) is the graph showing the input signal before being encoded, FIG. 14(b) is the graph of the power fluctuation ratio, and FIG. 14(c) is the graph of the prediction gain fluctuation ratio. In a section B and a section C, there is a change from a silent part to a sound part. In this case, the power fluctuation ratio also largely changes. Therefore, the second prior art is capable of detecting the signal change point in these sections.

In the section A, however, the property of the input signal changes from a steady part to a transition part. In this case, the power fluctuation ratio shows almost no change. Therefore, in this case, the second prior art is incapable of detecting the signal change. Hence, in this instance, the second prior art selects the long block. As by the second prior art, however, if the part with the signal being abruptly changed is processed with the long block, the pre-echo occurs. Consequently, the sound quality is deteriorated in the second prior art.

[Patent document 1] Japanese Patent Application Laid-Open Publication No. 7-66733

[Non-Patent document 1] Part 7 of ISO/IEC 13818-7, “Advanced Audio coding (ACC)”

As explained above, in the first prior art, the MDCT transform and the psychological auditory sense analysis are conducted for the long block and for the short block, respectively. Therefore, the first prior art has the problem that the throughput increases as compared with the case of processing by use of only the long block or the short block.

Further, the second prior art is incapable of detecting the change in the property of the signal unless the power fluctuation ratio changes even when the property of the input signal varies. Hence, the problem of the second prior art is that there might be a case of being unable to select the proper block length.

### SUMMARY OF THE INVENTION

It is an object of the present invention to provide an audio encoding apparatus and an audio encoding method that are capable of properly selecting the block length while reducing the throughput.

A first aspect of the present invention is an audio encoding apparatus comprising:

a power calculation unit that calculates a power fluctuation ratio based on the input signal;

a calculation unit that calculates a prediction gain fluctuation ratio based on the input signal; and

a block length judging unit that selects one of encoding using a long block mode segmenting an input signal into frames each consisting of a predetermined number of samples and encoding each of the frames, and encoding using a short block mode segmenting each of the frames into short blocks and encoding each of the short blocks, based on the power fluctuation ratio and the prediction gain fluctuation ratio.

Further, in the audio encoding apparatus according to the first aspect of the present invention, the block length judging unit selects the encoding using the short block mode if any one of the power fluctuation ratio and the prediction gain fluctuation ratio is larger than a predetermined threshold value, or selects the encoding using the long block mode.

Still further, the audio encoding apparatus according to the first aspect of the present invention further comprises a threshold value determining unit that changes a threshold value for judging a block length used by the block length judging unit when encoding, according to the selecting result of the block length judging unit.

Yet further, in the audio encoding apparatus according to the first aspect of the present invention, the threshold value determining unit sets the threshold value to a value larger than an initial value when the selecting result of the block length judging unit represents selection of the encoding using the short block mode.

Furthermore, in the audio encoding apparatus according to the first aspect of the present invention, the calculation unit calculates the prediction gain fluctuation ratio for a single block being combination of a predetermined number of blocks, each of which is used by the power calculation unit to calculate the power.

Moreover, in the audio encoding apparatus according to the first aspect of the present invention, the power calculation unit calculates the power fluctuation ratio of a single block being a combination of a predetermined number of blocks, each of which is used by the calculating unit to calculate a prediction gain.

Additionally, a second aspect of the present invention is an audio encoding apparatus comprising:

a power calculation unit that calculates a power fluctuation ratio based on the input signal;

a calculation unit that calculates a prediction gain fluctuation ratio based on the input signal;

a block length judging unit that selects one of encoding using a long block mode segmenting an input signal into frames each consisting of a predetermined number of samples and encoding each of the frames, and encoding using a short block mode segmenting each of the frames into short blocks and encoding each of the short blocks, based on the power fluctuation ratio and the prediction gain fluctuation ratio;

a first transformunit that obtains, if the block length judging unit selects the encoding using the long block mode, a first coefficient by executing modified discrete cosine transform (MDCT) of the input signal with a long block unit;

a second transform unit that obtains, if the block length judging unit selects the encoding using the short block mode, a second coefficient by executing modified discrete cosine transform of the input signal with a short block unit;

a selection unit that selects one of the first coefficient and the second coefficient as a third coefficient, according to the selecting result of the block length judging unit;

a psychological auditory sense analyzing unit that obtains a masking threshold value from the input signal;

a quantization unit that obtains a first code by spectrum-quantizing the third coefficient in accordance with the masking threshold value;

a Huffman coding unit that obtains a second code by Huffman-coding the first code;

a quantization control unit that calculates, from the second code, a total number of bits consisting of a bitstream to be outputted to instruct outputting the bitstream on the basis of a result of the calculation of the total number of bits; and

a bitstream generation unit that generates the bitstream from the second code to output the bitstream on the basis of an instruction from the quantization control unit.

Further, in the audio encoding apparatus according to the second aspect of the present invention, the block length judging unit selects the encoding based using the short block mode if any one of the power fluctuation ratio and the prediction gain fluctuation ratio is larger than a predetermined threshold value, or selects the encoding using the long block mode.

Still further, the audio encoding apparatus according to the second aspect of the present invention further comprises a threshold value determining unit that changes a threshold value for judging a block length used by the block length judging unit when encoding, according to the selecting result of the block length judging unit.

Yet further, in the audio encoding apparatus according to the second aspect of the present invention, the threshold value determining unit sets the threshold value to a value larger than an initial value when the selecting result of the block length judging unit represents selection of the encoding using the short block mode.

Furthermore, in the audio encoding apparatus according to the second aspect of the present invention, the calculation unit calculates the prediction gain fluctuation ratio for a single block being combination of a predetermined number of blocks, each of which is used by the power calculation unit to calculate the power.

Moreover, in the audio encoding apparatus according to the second aspect of the present invention, the power calculation unit calculates the power fluctuation ratio of a single block being a combination of a predetermined number of blocks, each of which is used by the calculating unit to calculate a prediction gain.

Further, a third aspect of the present invention is an audio encoding method comprising:

a power calculation step to calculate a power fluctuation ratio based on the input signal;

a calculation step to calculate a prediction gain fluctuation ratio based on the input signal; and

a block length judging step to select one of encoding using a long block mode segmenting an input signal into frames each consisting of a predetermined number of samples and encoding each of the frames, and encoding using a short block mode segmenting each of the frames into short blocks and encoding each of the short blocks, based on the power fluctuation ratio and the prediction gain fluctuation ratio.

Still further, a fourth aspect of the present invention is an audio encoding method comprising:

a power calculation step to calculate a power fluctuation ratio based on the input signal;

a calculation step to calculate a prediction gain fluctuation ratio based on the input signal;

a block length judging step to select one of encoding using a long block mode segmenting an input signal into frames each consisting of a predetermined number of samples and encoding each of the frames, and encoding using a short block mode segmenting each of the frames into short blocks and encoding each of the short blocks, based on the power fluctuation ratio and the prediction gain fluctuation ratio;

a first transform step to obtain, if the encoding using the long block mode is selected, a first coefficient by executing modified discrete cosine transform (MDCT) of the input signal with a long block unit;

a second transform step to obtain, if the encoding using the short block mode is selected, a second coefficient by discrete-cosine-transforming the input signal with a short block unit;

a selection step to select one of the first coefficient and the second coefficient as a third coefficient, according to the selecting result of the block length judging step;

a psychological auditory sense analyzing step to obtain a masking threshold value from the input signal;

a quantization step to obtain a first code by spectrum-quantizing the third coefficient in accordance with the masking threshold value;

a Huffman coding step to obtain a second code by Huffman-coding the first code;

a quantization control step to calculate, from the second code, a total number of bits consisting of a bitstream to be outputted to instruct outputting the bitstream on the basis of a result of the calculation of the total number of bits; and

a bitstream generation step to generate the bitstream from the second code to output the bitstream on the basis of an instruction outputted at the quantization control step.

In the audio encoding apparatus and the audio encoding method according to the present invention, it is judged, based on the power fluctuation ratio and the prediction gain fluctuation ratio whether the encoding is conducted based on the long block mode or the short block mode. Therefore, the audio encoding apparatus and the audio encoding method according to the present invention have no necessity of executing both of the encoding based on the long block and the encoding based on the short block. Hence, the audio encoding apparatus and the audio encoding method according to the present invention are capable of reducing the throughput and capable of performing the encoding based on the more proper block length because of judging the block length for encoding by use of both of the power fluctuation ratio and the prediction gain fluctuation ratio.

Moreover, the audio encoding apparatus and the audio encoding method according to the present invention are capable of preventing, e.g., the encoding based on the short block from being frequently selected and capable of reducing a decline of a sound quality of a sound to be outputted, by changing the block length judging threshold value used for the block length judgment in accordance with the judgment result about the block length.

Further, the audio encoding apparatus and the audio encoding method according to the present invention are capable of reducing the throughput by building up the single block in a way that uses the predetermined number of blocks from which the power is calculated and calculating the prediction gain fluctuation ratio of this single block.

Still further, the audio encoding apparatus and the audio encoding method according to the present invention are capable of reducing the throughput by building up the single block in a way that uses the predetermined number of blocks from which the prediction gain is calculated and calculating the power fluctuation ratio of this single block.

As described above, according to the present invention, it is possible to provide the audio encoding apparatus and the audio encoding method that are capable of properly selecting the block length while reducing the throughput.

### BRIEF DESCRIPTION OF THE DRAWINGS

FIG. 1 is a diagram of an outline of an audio encoding apparatus of the present invention;

FIG. 2 is a conceptual diagram of one example of a long block and a short block used in the audio encoding apparatus of the present invention;

FIG. 3 is a conceptual diagram of a method of calculating a prediction gain fluctuation ratio in the audio encoding apparatus of the present invention;

FIG. 4 is a diagram of a configuration in a first embodiment of the audio encoding apparatus of the present invention;

FIG. 5 is a flowchart of an operation for a block length judging method being carried out in the first embodiment of the audio encoding apparatus of the present invention;

FIG. 6 is a diagram of a configuration in a second embodiment of the audio encoding apparatus of the present invention;

FIG. 7 is a graph showing a threshold value control operation of a threshold value determining unit in the second embodiment of the audio encoding apparatus of the present invention;

FIG. 8 is a conceptual diagram of a method of obtaining the prediction gain fluctuation ratio and the power fluctuation ratio in a third embodiment of the audio encoding apparatus of the present invention;

FIG. 9 is a configuration diagram showing a calculation method of calculating the power fluctuation ratio in a fourth embodiment of the audio encoding apparatus of the present invention;

FIG. 10 is a configuration diagram showing a configuration of an MPEG-2 AAC encoder defined as a first prior art;

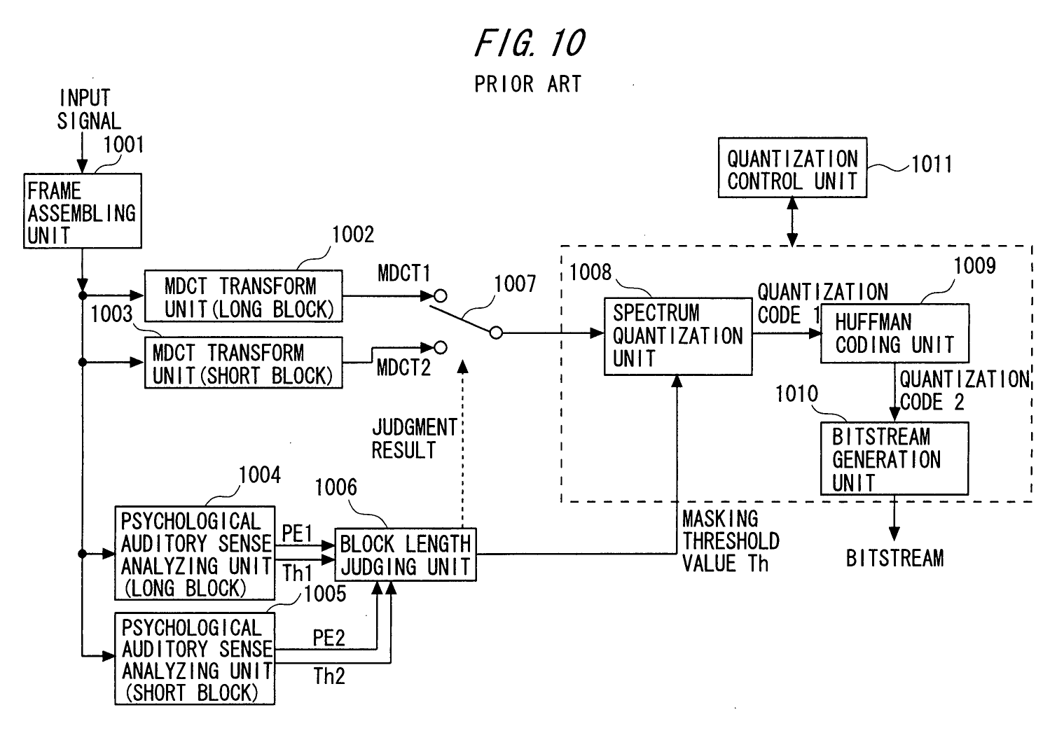

FIG. 11 is a schematic diagram showing an example of pre-echo;

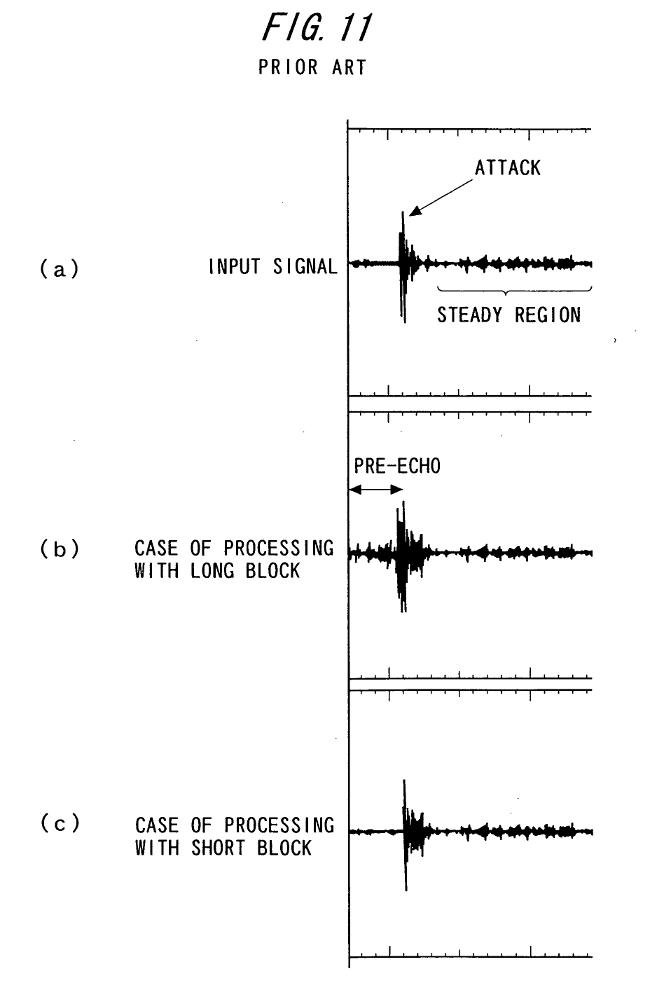

FIG. 12 is a configuration diagram showing a configuration in a second prior art;

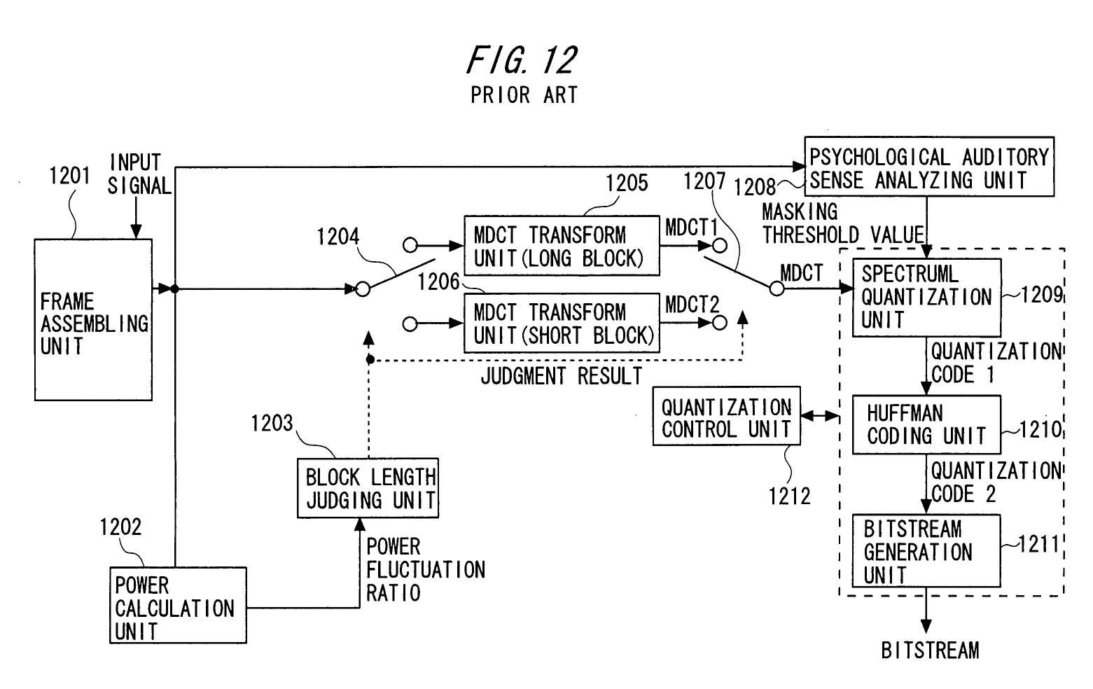

FIG. 13 is a conceptual diagram showing an example in the case of segmenting a frame into short blocks in the second prior art; and

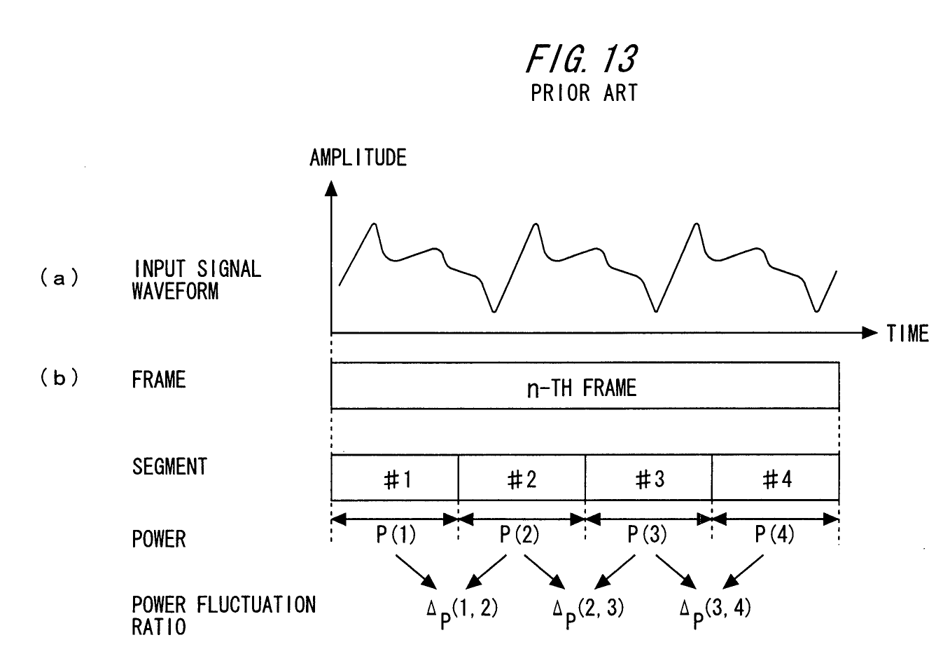

FIG. 14 is a graph showing examples of an input signal, the power fluctuation ratio and the prediction gain fluctuation ratio.

### DESCRIPTION OF THE REFERENCE NUMERALS AND SYMBOLS

101 frame assembling unit
102 power calculation unit
103 calculation unit
104 block length judging unit
105 selector
106 MDCT transforming unit
107 MDCT transforming unit
108 selector
109 psychological auditory sense analyzing unit
110 quantization unit
111 Huffman coding unit 111
112 bitstream generation unit
113 quantization control unit
401 frame assembling unit
402 power calculation unit
403 auto-correlation calculation unit
404 k-parameter calculation unit
405 prediction gain calculation unit
406 prediction gain fluctuation ratio calculation unit
407 block length judging unit
408 selector
409 MDCT transform unit for a long block
410 MDCT transform unit for a short block
411 selector
412 psychological auditory sense analyzing unit
413 quantization unit
414 Huffman coding unit 111
415 bitstream generation unit
416 quantization control unit
601 frame assembling unit
602 power calculation unit
603 auto-correlation calculation unit
604 k-parameter calculation unit
605 prediction gain calculation unit
606 prediction gain fluctuation ratio calculation unit
607 block length judging unit
608 threshold value determining unit
609 selector
610 MDCT transform unit for a long block
611 MDCT transform unit for a short block
612 selector
613 psychological auditory sense analyzing unit
614 quantization unit
615 Huffman coding unit 111
616 bitstream generation unit
617 quantization control unit

### DETAILED DESCRIPTION OF THE PREFERRED EMBODIMENTS

### Outline of the Present Invention

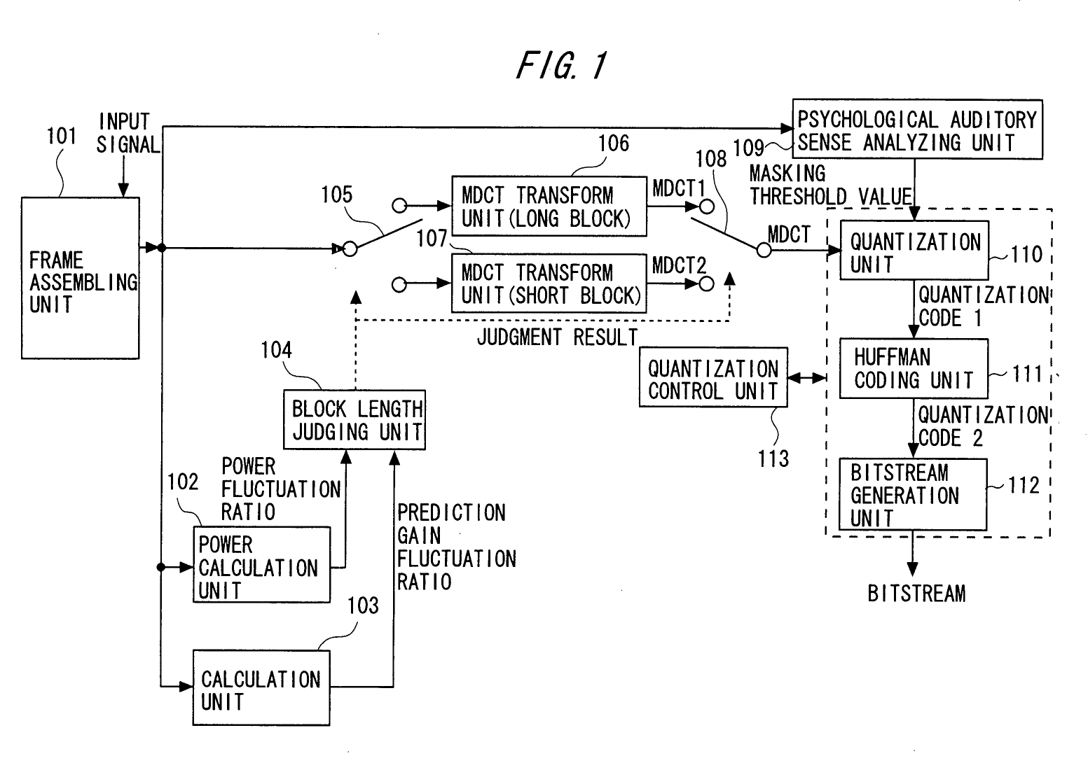

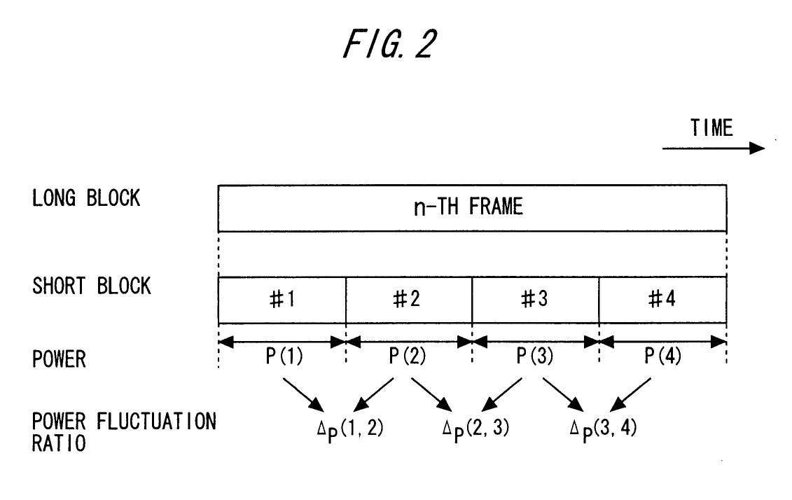

A best mode for carrying out the present invention will hereinafter be described with reference to the drawings. To start with, outlines of an audio encoding apparatus and an audio encoding method according to the present invention will be explained. FIG. 1 is a diagram of the outline of the audio encoding apparatus of the present invention. The following discussion serves also as an explanation of the outline of the audio coding method of the present invention. In FIG. 1, a frame assembling unit 101 segments input signals into input signal frames (long blocks) each consisting of a predetermined number of samples (sample count). Next, an MDCT transforming unit 106 for the long block, an MDCT transforming unit 107 for a short block, a power calculation unit 102 and a calculation unit 103 segment one frame into short blocks that are each much shorter than the long block. FIG. 2 is a conceptual diagram showing one example of the long block and the short block, which are used in the audio encoding apparatus of the present invention. FIG. 2 shows a case of segmenting one frame (the long block) into four short blocks. The following discussion will be made based on the example illustrated in FIG. 2. The present invention canbe, however, carried out in the same way even in the case of segmenting one frame into n-pieces (n>0) of short blocks.

(1) The power calculation unit 102 obtains input signal powers P(1), P(2), P(3), P(4) for every short block. Next, the power calculation unit 102 obtains power fluctuation ratios Δ_{P} (1, 2), Δ_{P} (2, 3), Δ_{P} (3, 4) between the neighboring blocks. Herein, Δ_{P} (i, j) represents the power fluctuation ratio between a short block i and a short block j and is obtained by the formula (1) described above.

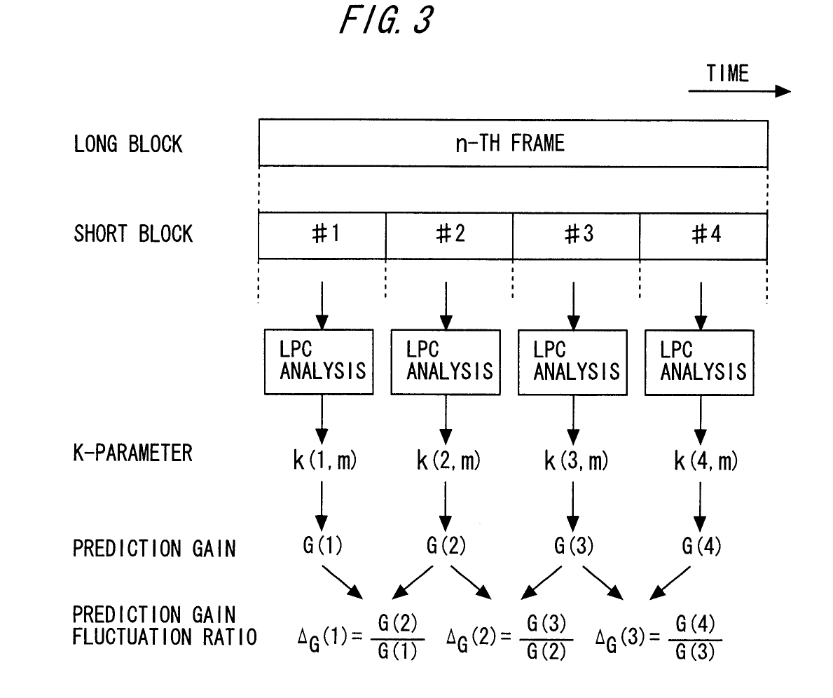

(2) Next, the calculation unit 103 acquires a k-parameter by executing an LPC (Linear Predictive Coding) analysis (linear prediction analysis method) about the input signal of the short block. FIG. 3 is a conceptual diagram showing a calculation method of calculating a prediction gain fluctuation ratio in the audio encoding apparatus of the present invention. In the present invention, the calculation method of calculating the k-parameter is arbitrary. The present invention can, however, involve using a method of calculating the k-parameter from an auto-correlation function by a known method such as the Levinson algorithm in a way that obtains the auto-correlation function from, e.g., the input signal.

(3) Next, the calculation unit 103 obtains a prediction gain G(i) by the following formula from the k-parameter k(i, m) (m=1, . . . , p) acquired from the short block i. Herein, p is a prediction degree.

$$G ( i ) = \frac{1}{{\prod }_{m = 1}^{p} ( 1 - {k ( i , m )}^{2} )} \qquad [ Formula 2 ]$$

(4) Next, the calculation unit 103 obtains a prediction gain fluctuation ratio Δ_{G} (i, j) by the following formula from the prediction gains G(i), G(j) acquired from the short blocks i, j.

$${Δ}_{G} ( i , j ) = \frac{G ( j )}{G ( i )} \qquad [ Formula 3 ]$$

(5) Subsequently, the power fluctuation ratio Δ_{P} (i, j) is inputted to a block length judging unit 104. Further, the prediction gain fluctuation ratio Δ_{G} (i, j) is inputted to the block length judging unit 104. Then, the block length judging unit 104 judges which block, the long block or the short block, is used for quantization. A judging method of the block length judging unit 104 can involve employing the following method. It should be noted that a phrase “the block length judging unit selects the long block” implies in the following discussion that the block length judging unit selects encoding based on the long block. Similarly, a phrase “the block length judging unit selects the short block” implies that the block length judging unit selects encoding based on the short block. Namely, the phrase “the block length judging unit selects the block implies that the block length judging unit selects encoding based on the block thereof.

A) The block length judging unit 104 sets a threshold value TH_{P}with respect to the power fluctuation ratio and the prediction gain fluctuation ratio TH_{G}.

B) Next, the block length judging unit 104 selects the short block if there is even one ratio among the ratios Δ_{P} (1, 2), Δ_{P} (2, 3), Δ_{P} (3, 4), which is larger than the threshold value TH_{P}but advances to next step C) whereas if not.

C) Subsequently, the block length judging unit 104 selects the short block if there is even one ratio among the ratios Δ_{G} (1, 2), Δ_{G} (2, 3), Δ_{G} (3, 4), which is larger than the threshold value TH_{G} but selects the long block whereas if not.

Namely, the block length judging unit 104 selects the short block only when any one of the power fluctuation ratio and the prediction gain fluctuation ratio within the frame exceeds the preset threshold value, and selects the long block in other cases.

(6) If the block length judging unit 104 selects the long block, a result of this judgment is outputted to a selector 105 and a selector 108. The selector 105 and the selector 108 select the block on the basis of the judgment result. Therefore, if the block length judging unit 104 selects the long block, the selector 105 and the selector 108 select the long block.

Then, the input signal outputted from the frame assembling unit 101 is inputted to the MDCT transform unit 106 for the long block. Then, the MDCT transform unit 106 for the long block outputs MDCT1.

Further, if the block length judging unit 104 selects the short block, a result of this judgment is outputted to the selector 105 and the selector 108. Then, the selector 105 and the selector 108 select the short block

Then, the input signal outputted from the frame assembling unit 101 is inputted to the MDCT transform unit 107 for the short block. Subsequently, the MDCT transform unit 107 for the short block outputs MDCT coefficients by the number of short blocks (short block count). Namely, if one frame is segmented into four short blocks, the MDCT transform unit 107 for the short block outputs the 4-tuple MDCT coefficient.

(7) Next, a psychological auditory sense analyzing unit 109 obtains a masking threshold value from the input signal inputted. Herein, the psychological auditory sense analyzing unit 109, if the block length judging unit 104 selects the long block, obtains a masking threshold value for the long block. Further, the psychological auditory sense analyzing unit 109, if the block length judging unit 104 selects the short block, obtains a masking threshold value for the short block.

In the present invention, a masking threshold value calculation method may take an arbitrary method. For instance, the psychological auditory sense analyzing unit 109 can employ a method disclosed in Non-Patent document 1. To be specific, the psychological auditory sense analyzing unit 109 performs an FFT (Fast Fourier Transform) analysis about the input signal. Then, the psychological auditory sense analyzing unit 109 acquires an FFT spectrum. Subsequently, the psychological auditory sense analyzing unit 109 calculates the masking threshold value from the FFT spectrum.

(8) Next, the MDCT coefficient and the masking threshold value are inputted to a quantization unit 110. The quantization unit 110 quantizes the MDCT coefficient for every frequency band in accordance with the inputted masking threshold value. Then, the quantization unit 110 outputs a quantization code 1 into which the MDCT coefficient is quantized.

(9) Next, the quantization code is inputted to a Huffman coding unit 111. Then, the Huffman coding unit 111 transforms the quantization code 1 into a quantization code 2 of which redundancy is removed much further than the quantization code 1.

(10) Subsequently, the Huffman coding unit 111 outputs the quantization code 2 to a quantization control unit 113. The quantization control unit 113 calculates a total bit count of a bitstream to be finally outputted from the inputted quantization code 2. Note that a range encompassed by a dotted line in FIG. 1 represents a controllable range of the quantization control unit 113.

(11) The quantization control unit 113, if the calculated total bit count is greater than a bit count allowable to the present block, controls the quantization unit 110 and the Huffman coding unit 111 to repeat the processes (8) through (10). Further, the quantization control unit 113, if the calculated total bit count is smaller than the bit count allowable to the present block, controls the Huffman coding unit 111 to output the quantization code 2 to a bitstream generation unit 112. Then, the quantization control unit 113 controls the bitstream generation unit 112 to output the bitstream. With this operation, the audio encoding apparatus shown in FIG. 1 actualizes the quantization. It is to be noted that the quantization process in the present invention is the same as the details of the quantization process of the AAC method explained in the column “Description of the Prior Art” given above, and hence an in-depth description thereof is omitted.

Next, embodiments of the present invention will be explained with reference to the drawings. Configurations in the following embodiments are exemplifications, and the present invention is not limited to the configurations in the embodiments. Further, the description of each of the following embodiments is made by exemplifying the audio encoding apparatus that encodes the audio signal. It should be noted that the description, given as below, of each of the embodiments of the audio encoding apparatus of the present invention serves also as a description of each of embodiments of the audio encoding method of the present invention.

### First Embodiment

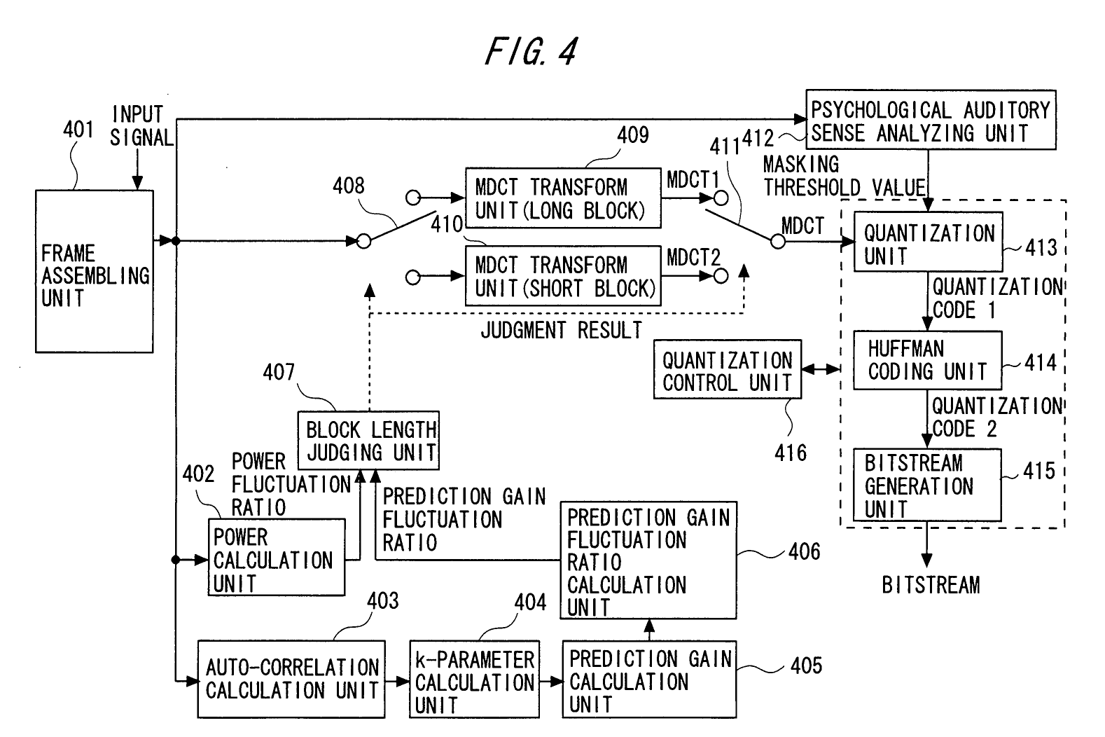

FIG. 4 is a diagram of a configuration in a first embodiment of the audio encoding apparatus of the present invention. In FIG. 4, a frame assembling unit 401 segments inputted signals into input signal frames (long blocks) each consisting of a predetermined sample count.

Next, an MDCT transform unit 410 for the short block, a power calculation unit 402 and an auto-correlation calculation unit 403 segment an inputted single frame into short blocks. The frame segmentation in the first embodiment will be explained with reference to FIG. 2 given above. FIG. 2 is the conceptual diagram showing the example of the long block and the short block. In the example depicted in FIG. 2, one frame (long block) is segmented into four short blocks. The following discussion will be made based on this example. The first embodiment is, however, established in the same way also in the case of segmenting one frame into n-pieces of short blocks (n is a non-negative integer).

(1) At first, the power calculation unit 402 obtains input signal powers P(1), P(2), P(3), P(4) for every short block. Next, the power calculation unit 402 obtains power fluctuation ratios Δ_{P} (1, 2), Δ_{P} (2, 3), Δ_{P} (3, 4)between the neighboring blocks. Herein, Δ_{P} (i, j) represents the power fluctuation ratio between the short block i and the short block j . This power fluctuation ratio is obtained by the formula (1) described above.

(2) Next, the auto-correlation calculation unit 403 obtains an auto-correlation from the input signal of the short block. Then, the auto-correlation calculation unit 403 outputs this auto-correlation to a k-parameter calculation unit 404.

subsequently, the k-parameter calculation unit 404 calculates the k-parameter by a known method such as the Levinson algorithm from the auto-correlation function. Note that the k-parameter calculation unit 404 may obtain an LPC coefficient from the auto-correlation function and may transform the LPC coefficient into the k-parameter.

(3) Then, aprediction gain calculation unit 405 acquires a prediction gain G(i) by the following formula from the k-parameter k(i, m) (m=1, . . . , p) obtained from the short block i. Herein, p is the prediction degree. This prediction gain G(i) is inputted to a prediction gain fluctuation ratio calculation unit 406.

$$G ( i ) = \frac{1}{{\prod }_{m = 1}^{p} ( 1 - {k ( i , m )}^{2} )} \qquad [ Formula 4 ]$$

(4) Next, the prediction gain fluctuation ratio calculation unit 406 obtains the prediction gain fluctuation ratio Δ_{G} (i, j) by the following formula from the prediction gains G(i), G(j) acquired from the short block i and the short block j. Herein, the auto-correlation calculation unit 403, the k-parameter calculation unit 404, the prediction gain calculation unit 405 and the prediction gain fluctuation ratio calculation unit 406 may be configured as part of the functions of the calculation unit 103 shown in FIG. 1.

$${Δ}_{G} ( i , j ) = \frac{G ( j )}{G ( i )} \qquad [ Formula 5 ]$$

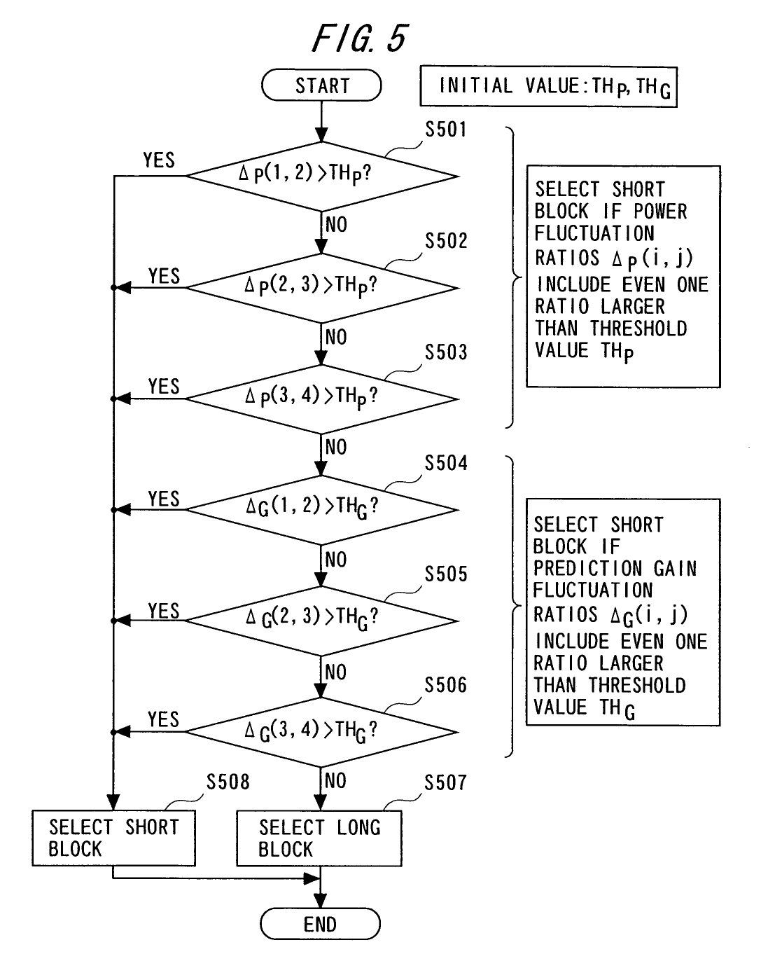

(5) Subsequently, the power fluctuation ratio Δ_{P} (i, j) and the prediction gain fluctuation ratio Δ_{G} (i, j) are inputted to a block length judging unit 407. Then, the block length judging unit 407 judges which block, the long block or the short block, is used for quantization. A judging method of the block length judging unit 407 can involve employing the following method. The judging method executed by the block length judging unit will hereinafter be explained with reference to FIG. 5. FIG. 5 is a flowchart showing an operation of the block length judging method conducted in the first embodiment of the audio encoding apparatus of the present invention. It should be, as described above, noted that the phrase “the block length judging unit selects the long block” implies in the following discussion that the block length judging unit selects encoding based on the long block. Similarly, a phrase “the block length judging unit selects the short block” implies that the block length judging unit selects encoding based on the short block. Namely, the phrase “the block length judging unit selects the block implies that the block length judging unit selects encoding based on the block thereof.

(A) The block length judging unit 407 sets the threshold value TH_{P} with respect to the power fluctuation ratio and the threshold value TH_{G} with respect to the prediction gain fluctuation ratio.

(B) Next, the block length judging unit 407 selects the short block if there is even one ratio among the ratios Δ_{P} (1, 2), Δ_{P} (2, 3), Δ_{P} (3, 4), which is larger than the threshold value TH_{P} (S501, S502, S503, S508) but advances to next step (C) whereas if not.

(C) The block length judging unit 407 selects the short block if there is even one ratio among the ratios Δ_{G} (1, 2), Δ_{G} (2, 3), Δ_{G} (3, 4), which is larger than the threshold value TH_{G} (S504, S505, S506, S508) but selects the long block whereas if not (S507).

Namely, the block length judging unit 407 selects the short block only when any one of the power fluctuation ratio and the prediction gain fluctuation ratio within the frame exceeds the preset threshold value, and selects the long block in other cases.

(6) A result of judgment of the block length judging unit 407 is inputted to a selector 408 and a selector 411. The selector 408 and a selector 411 select the block length to be used on the basis of the judgment result of the block length judging unit 407.

If the block length judging unit 407 selects the long block, the input signal is inputted to an MDCT transform unit 409 for the long block. Then, the MDCT transform unit 409 for the long block outputs an MDCT coefficient.

Further, if the block length judging unit 407 selects the short block, the input signal is inputted to an MDCT transform unit 410 for the short block. Then, the MDCT transform unit 410 for the short block outputs MDCT coefficients by the short block count. Namely, if one frame is segmented into four short blocks, the MDCT transform unit 410 for the short block outputs the 4-tuple MDCT coefficient.

(7) Next, a psychological auditory sense analyzing unit 412 obtains a masking threshold value from the input signal inputted. The input signal outputted from the frame assembling unit 401 is inputted to the psychological auditory sense analyzing unit 412. Herein, the psychological auditory sense analyzing unit 412, if the block length judging unit 407 selects the long block, obtains a masking threshold value for the long block. Further, the psychological auditory sense analyzing unit 412, if the block length judging unit 407 selects the short block, obtains a masking threshold value for the short block.

In the first embodiment, the masking threshold value calculation method may take an arbitrary method. For instance, the psychological auditory sense analyzing unit 412 can employ the method disclosed in Non-Patent document 1. To be specific, the psychological auditory sense analyzing unit 412 performs the FFT (Fast Fourier Transform) analysis about the input signal. Then, the psychological auditory sense analyzing unit 412 acquires the FFT spectrum. Subsequently, the psychological auditory sense analyzing unit 412 calculates the masking threshold value from the FFT spectrum.

(8) The MDCT coefficient and the masking threshold value are inputted to a quantization unit 413. The quantization unit 413 quantizes the MDCT coefficient for every frequency band in accordance with the inputted masking threshold value. The quantization unit 413 outputs the quantization code 1 into which the MDCT coefficient is quantized.

(9) Next, the quantization code 1 is inputted to a Huffman coding unit 414. Then, the Huffman coding unit 414 transforms the quantization code 1 into the quantization code 2 of which the redundancy is removed much further than the quantization code 1.

(10) Subsequently, the Huffman coding unit 414 outputs the quantization code 2 to a quantization control unit 416. The quantization control unit 416 calculates a total bit count of a bitstream to be finally outputted from the inputted quantization code 2. Note that a range encompassed by a dotted line in FIG. 4 represents a controllable range of the quantization control unit 416.

(11) The quantization control unit 416, if the calculated total bit count is greater than a bit count allowable to the present block, controls the quantization unit 413 and the Huffman coding unit 414 to repeat the processes (8) through (10). Further, the quantization control unit 416, if the calculated total bit count is smaller than the bit count allowable to the present block, controls the Huffman coding unit 414 to output the quantization code 2 to a bitstream generation unit 415. Then, the quantization control unit 415 controls the bitstream generation unit 415 to output the bitstream. With this operation, the first embodiment actualizes the quantization. It is to be noted that the quantization process in the first embodiment is the same as the details of the quantization process of the AAC method explained in the column “Description of the Prior Art” given above, and hence an in-depth description thereof is omitted.

It is to be noted that the first embodiment has exemplified the case of segmenting one frame into the four short blocks. The present invention can be actualized similarly in the case of segmenting one frame into an arbitrary number blocks (e.g., 8 blocks).

As discussed so far, the first embodiment is, since the block length is judged before the MDCT transform, capable of encoding the high-quality audio signal with a less throughput than by the first prior art. Moreover, the first embodiment is, the block length being judged by use of the power fluctuation ratio and the prediction gain fluctuation ratio and being consequently judged with higher accuracy than by the second prior art, therefore capable of encoding the higher-quality audio signal than by the second prior art.

Namely, the first embodiment is that the block length for executing the encoding is judged before the MDCT transform and the psychological auditory sense analysis. Therefore, the first embodiment enables the high-quality encoding with the less throughput than by the first prior art. Moreover, in the first embodiment, the block length judging unit uses the power fluctuation ratio and the prediction gain fluctuation ratio. Hence, the first embodiment is capable of judging the block length with the higher accuracy than by the second prior art.

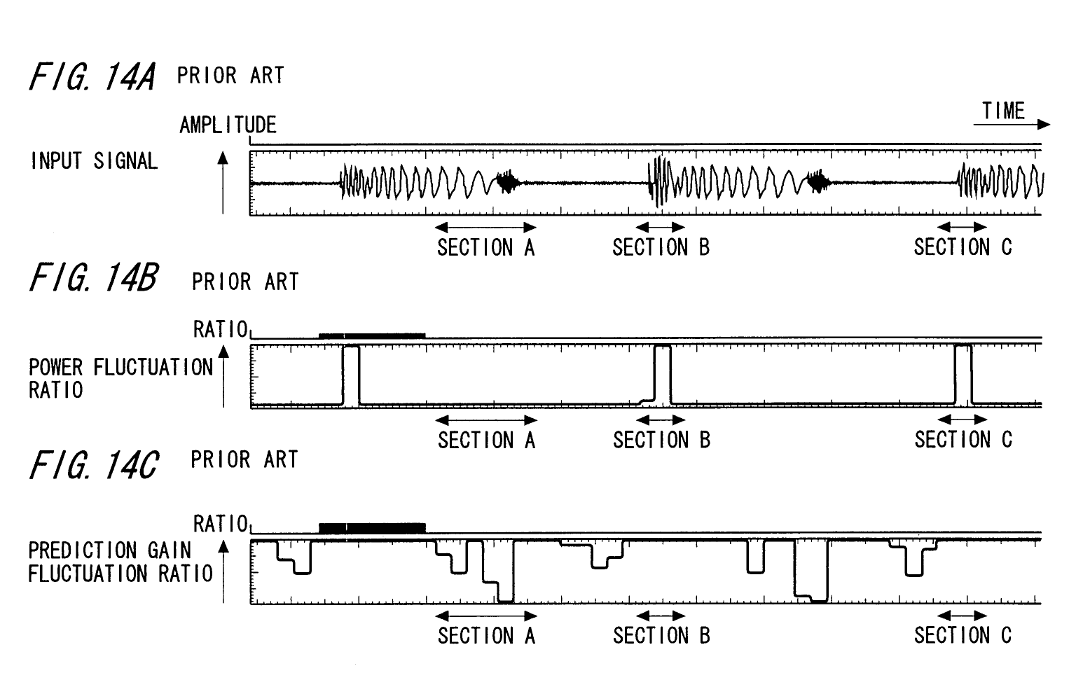

The effect of the first embodiment will be explained in greater detail with reference to FIG. 14 given above. FIG. 14 shows graphs of calculation results of the power fluctuation ratio and the prediction gain fluctuation ratio. The input signal depicted in FIG. 14(a) shows almost no change, wherein a value of the power fluctuation ratio is 0 in a section A (FIG. 14(b)). By contrast, the input signal shown in FIG. 14(a) largely fluctuates in the prediction gain fluctuation ratio in the section A (FIG. 14(c)).

In the first embodiment, both of the power fluctuation ratio and the prediction gain fluctuation ratio are calculated. Then, if one of the power fluctuation ratio and the prediction gain fluctuation ratio exceeds the threshold value, the short block is chosen. The first embodiment is therefore capable of judging the block length with the high accuracy with respect to even the input signal as in the section A depicted in FIG. 14.

Note that in sections B and C illustrated in FIG. 14, the prediction gain fluctuation ratio shows almost no fluctuation. While on the other hand, the power fluctuation ration largely fluctuates in the sections B and C shown in FIG. 14. Accordingly, the first embodiment enables the point of change of the signal to be detected in the sections B and C in the same way as by the second prior art.

### Second Embodiment

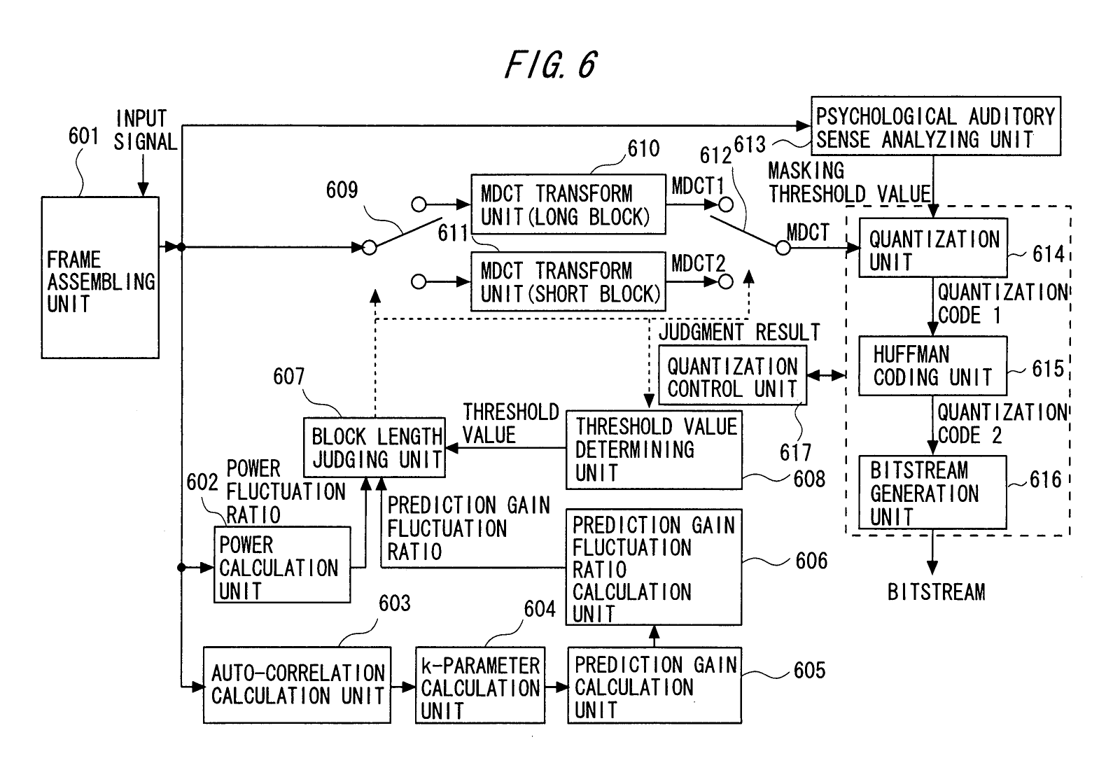

FIG. 6 is a diagram of a configuration in a second embodiment of the audio encoding apparatus of the present invention. A difference of the second embodiment from the first embodiment is a scheme of dynamically changing the threshold value TH_{P}with respect to the power fluctuation ratio and the threshold value TH_{G} with respect to the prediction gain fluctuation ratio. The operations other than this scheme are common to those in the first embodiment and are therefore omitted in their explanations.

Generally, in many cases, the short block is selected in an abruptly changing area as in an attack sound etc. The attack sound is large of amplitude of the MDCT spectrum over a broad frequency range. Hence, the attack sound requires a tremendous quantization bit count in the case of encoding.

If the short block is consecutively selected, there might be a case in which the sound quality extremely declines due to deficiency of the quantization bit count. Therefore, such a case may arise that the encoding of the audio signal at a low bit rate involves controlling the short block not to be consecutively selected to the greatest possible degree.

Such being the case, in the second embodiment, if the short block is once selected, the threshold value TH_{P}and the threshold value TH_{G} are thereafter increased for a fixed period of time. As a result, the second embodiment takes the scheme that the short block is not consecutively selected to the greatest possible degree.

Herein, a configuration in the second embodiment of the audio encoding apparatus of the present invention will be explained. The configuration in the second embodiment is illustrated in FIG. 6. Then, among the respective blocks shown in FIG. 6, the blocks other than a block length judging unit 607 and a threshold value determining unit 608 have the same operations as those of the respective corresponding blocks depicted in FIG. 4, and hence their detailed descriptions are omitted.

Specifically, a frame assembling unit 601 illustrated in FIG. 6 has the same operation as the operation of the frame assembling unit 401 shown in FIG. 4, a power calculation unit 602 has the same operation as the operation of the power calculation unit 402 shown in FIG. 4, an auto-correlation calculation unit 603 has the same operation as the operation of the auto-correlation calculation unit 403 shown in FIG. 4, an k-parameter calculation unit 604 has the same operation as the operation of the k-parameter calculation unit 404 shown in FIG. 4, and aprediction gain calculation unit 605 has the same operation as the operation of the prediction gain calculation unit 405 shown in FIG. 4.

Moreover, a prediction gain fluctuation ratio calculation unit 606 has the same operation as the operation of the prediction gain fluctuation ratio calculation unit 406 illustrated in FIG. 4, a selector 609 has the same operation as the operation of the selector 408 illustrated in FIG. 4, and an MDCT transform unit 610 for the long block has the same operation as the operation of the MDCT transform unit 409 for the long block illustrated in FIG. 4.

Further, an MDCT transform unit 611 for the short block has the same operation as the operation of the MDCT transform unit 410 for the short block illustrated in FIG. 4, a selector 612 has the same operation as the operation of the selector 411 illustrated in FIG. 4, a psychological auditory sense analyzing unit 613 has the same operation as the operation of the psychological auditory sense analyzing unit 412 illustrated in FIG. 4, a quantization unit 614 has the same operation as the operation of the quantization unit 413 illustrated in FIG. 4, a Huffman coding unit 615 has the same operation as the operation of the Huffman coding unit 414 illustrated in FIG. 4, a bitstream generation unit 616 has the same operation as the operation of the bitstream generation unit 415 illustrated in FIG. 4, and a quantization control unit 617 has the same operation as the operation of the quantization control unit 416 illustrated in FIG. 4. Note that a range encompassed by a dotted line in FIG. 6 represents a controllable range of the quantization control unit 617.

On the other hand, the block length judging unit 607 shown in FIG. 6 receives the threshold value determined by the threshold value determining unit 608. Further, the block length judging unit 607 outputs the judgment result about the block length to the selector 609, the selector 612 and the threshold value determining unit 608. The threshold value determining unit 608 determines the threshold value on the basis of the judgment result outputted from the block length judging unit 607. Namely, the threshold value determining unit 608, if the judgment result outputted from the block length judging unit 607 shows the selection of the short block, outputs an increased threshold value. Moreover, the block length judging unit 607 executes the judging process on the basis of the threshold value received from the threshold value determining unit 608. Except a point that the threshold value is possible of fluctuating, the judging process in the block length judging unit 607 is the same as in the case shown in FIG. 5 given above, and hence its in-depth explanation is omitted. Moreover, the threshold value determining unit 608 may be configured to be part of the functions of the calculation unit 103 illustrated in FIG. 1.

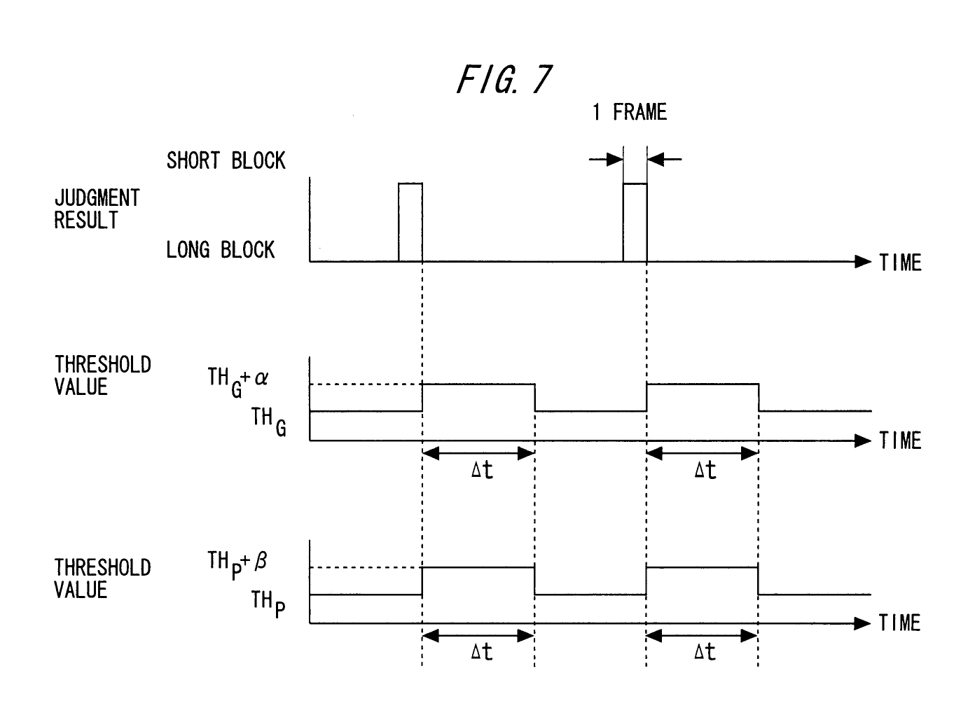

FIG. 7 shows graphs each illustrating a threshold value control operation in the threshold value determining unit in the second embodiment of the audio encoding apparatus of the present invention. In the graphs shown in FIG. 7, when the short block is selected, the threshold value TH_{G} is changed to TH_{G}+a. Herein, a relation shall be established such as a>0. Similarly, when the short block is selected, the threshold value TH_{P}is changed to TH_{P}+β. Herein, a relation shall be established such as β>0.

Thereafter, when a fixed period of timeΔt elapses, the threshold values are changed to the original values (the initial values) TH_{G}, TH_{P}. Namely, a scheme in the second embodiment is that if the short block is once selected, thereafter the short block is not consecutively selected to the greatest possible degree by increasing the threshold value TH_{P}and the threshold value TH_{G} for the fixed period of time.

As explained above, the second embodiment is capable of acquiring the same effect as in the first embodiment discussed above. Furthermore, in the second embodiment, if the short block is once selected, the threshold values are thereafter controlled so that the short block is not selected for the fixed period time. Hence, the second embodiment is capable of reducing the deterioration of the sound quality, which is caused by the consecutive selection of the short block.

It should be noted that the following method can be also carried out as a modified example of the second embodiment. The modified example given below can acquire the same effect as in the second embodiment of the audio encoding apparatus of the present invention.

(1) In the modified example of the first embodiment, after the short block has been selected, the short block is not selected for the fixed period of time.

(2) In the modified example of the first embodiment, after the short block has been selected, a or β is set sufficiently large. The modified example of the first embodiment, however, needs checking the range of TH_{G} or TH_{P}beforehand.

(3) In the modified example of the first embodiment, in a case where the short block is selected and the threshold value is set to TH_{G}+a or TH_{P}+β, if the short block is again selected, the threshold value is set to TH_{G}+a+a or TH_{P}+β+β. In the modified example of the second embodiment, however, the threshold value is set back to the original value after the fixed period of time.

### Third Embodiment

Next, a third embodiment of the audio encoding apparatus of the present invention will be described. A configuration in the third embodiment is the same as in the first embodiment shown in FIG. 4. A different point of the third embodiment from the first embodiment is, however, such that the prediction gain fluctuation ratio is obtained on a frame-by-frame basis (with a frame unit). Namely, a scheme of the third embodiment is that a single block is built up by employing a predetermined number of blocks for the power calculation, and the prediction gain fluctuation ratio of this single block is calculated.

In the first embodiment, the LPC analysis is conducted for every short block. The first embodiment is therefore capable of precisely calculating the prediction gain fluctuation ratio. In the first embodiment, however, the throughput rises because of an increased execution count of the LPC analysis. In the third embodiment, the LPC analysis is conducted once for one long block. Therefore, the third embodiment is capable of reducing a quantity of the arithmetic operation to a greater degree than in the first embodiment.

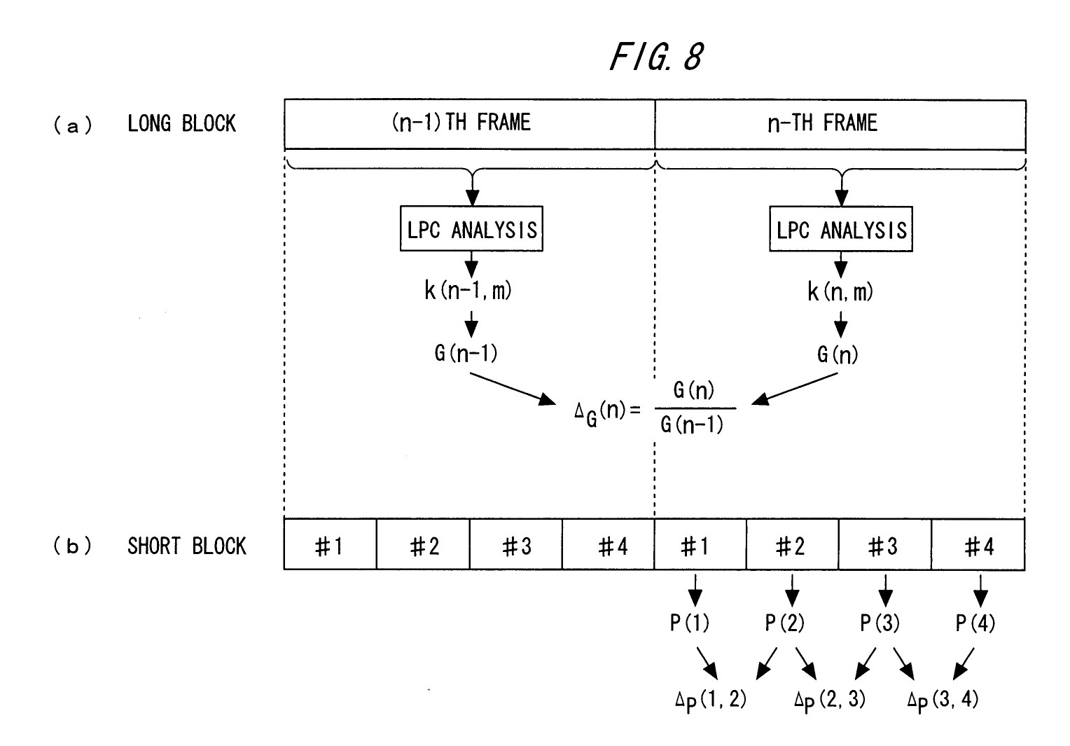

FIG. 8 is a conceptual diagram of a method of obtaining the prediction gain fluctuation ratio and the power fluctuation ratio in the third embodiment of the audio encoding apparatus of the present invention. In the first embodiment, the prediction gain is acquired from the k-parameter obtained by conducting the LPC analysis for every short block. Then, in the first embodiment, the prediction gain fluctuation ratio is calculated based on a ratio to the prediction gain acquired in the same way from the short block existing one before.

By contrast, in the third embodiment, as shown in FIG. 8(a), the k-parameter is obtained by performing the LPC analysis about the input signal of one long block (the n-th frame). To be specific, the k-parameter calculation unit acquires the k-parameter by conducting the LPC analysis with respect to the input signal of one long block (the n-th frame). Then, in the third embodiment, a prediction gain G(n) is calculated from the k-parameter. Next, in the third embodiment, a prediction gain fluctuation ratio Δ_{G}(n) is calculated in the following formula by use of the prediction gain fluctuation ratios G(n−1) and G(n) obtained in the same way from the frame (an (n−1)th frame) existing one before.

$${Δ}_{G} ( n ) = \frac{G ( n )}{G ( n - 1 )} \qquad [ Formula 6 ]$$

On the other hand, in the third embodiment, as shown in FIG. 8(b), the power fluctuation ratios Δ_{P} (1, 2), Δ_{P} (2, 3), Δ_{P} (3, 4) are calculated for every short block in the same manner as in the first embodiment. Next, in the third embodiment, an optimum block length is determined from the thus-calculated prediction gain fluctuation ratio and power fluctuation ratio. This determining operation will hereinafter be described.

(1) The block length judging unit selects the short block if Δ_{G}(n) is larger than the predetermined threshold value TH_{G}.

(2) Next, the block length judging unit selects the short block if there is even one ratio among the ratios Δ_{P} (1, 2), Δ_{P} (2, 3), Δ_{P} (3, 4), which is larger than the threshold value TH_{P}.

(3) Then, the block length judging unit selects the long block if the short block is not chosen in any one of the processes (1) and (2). The third embodiment is common to the first embodiment in terms of the configuration and the processing content after selecting the block length. Therefore, the configuration and the processing content after selecting the block length in the third embodiment are omitted in their explanations.

As explained above, the third embodiment can acquire the same effect as in the first embodiment of the present invention discussed above. Furthermore, the third embodiment is capable of selecting the block length with the less throughput than in the first embodiment by conducting the LPC analysis once with respect to the long block. In the third embodiment, however, since the block for calculating the prediction gain is not limited to the case of employing the blocks of one frame, the single block is built up by use of an arbitrary number of blocks for calculating the power, and the prediction gain of this single block may also be calculated. In this case also, the third embodiment is capable of acquiring the same effect as the above-mentioned.

### Fourth Embodiment

Next, a fourth embodiment of the audio encoding apparatus of the present invention will be explained. A configuration in the fourth embodiment is the same as the configuration in the first embodiment. A difference of the fourth embodiment from the first embodiment is, however, a calculation method of calculating the power fluctuation ratio in a way that segments one frame into eight pieces of short blocks. Specifically, the single block is built up by employing the predetermined number of blocks for calculating the prediction gain, and the power fluctuation ratio of this single block is calculated.

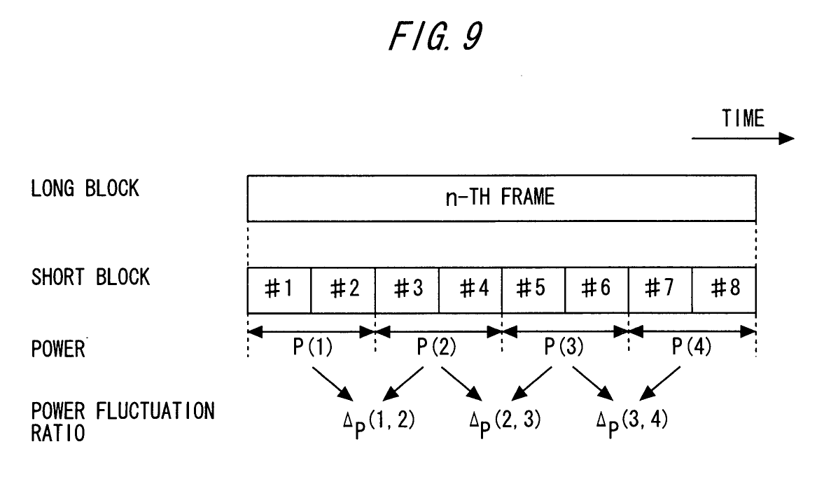

FIG. 9 is a conceptual diagram showing the calculation method of calculating the power fluctuation ratio in the fourth embodiment of the audio encoding apparatus of the present invention. As illustrated in FIG. 9, in the fourth embodiment, one frame is segmented into the eight short blocks, and the power fluctuation ratio is calculated. Unlike the first embodiment, however, the fourth embodiment does not take the scheme that the single power fluctuation ratio is obtained with respect to one short block. Namely, the fourth embodiment is different from the first embodiment in terms of obtaining the power fluctuation ratio from a plurality of neighboring short blocks. The power fluctuation ratio calculation method in the fourth embodiment will be shown as below.

In the fourth embodiment, the power P(1) is obtained from the first and second short blocks. Further, in the fourth embodiment, the power P(2) is obtained from the third and fourth short blocks. Still further, in the fourth embodiment, the power P(3) is obtained from the fifth and sixth short blocks. Yet further, in the fourth embodiment, the power P(4) is obtained from the seventh and eighth short blocks.

Next, in the fourth embodiment, the power fluctuation ratio Δ_{P} (1, 2) is acquired from P(1) and P(2). Furthermore, in the fourth embodiment, the power fluctuation ratio Δ_{P} (2, 3) is acquired from P(2) and P(3). Moreover, in the fourth embodiment, the power fluctuation ratio Δ_{P} (3, 4) is acquired from P(3) and P(4).

As described above, the fourth embodiment is different from the first embodiment in terms of obtaining the power from the two short blocks. Specifically, the first embodiment performs the calculation of eight pieces of prediction gain fluctuation ratios and eight pieces of power fluctuation ratios, and, in contrast with this, the fourth embodiment performs the calculation of eight pieces of prediction gain fluctuation ratios and only four pieces of power fluctuation ratios. Namely, in the fourth embodiment, there may exist a difference between the number of the prediction gain fluctuation ratios and the number of the power fluctuation ratios, which are calculated within one frame. Operations other than the above-mentioned in the fourth embodiment are the same as those in the first embodiment, and hence their explanations are omitted.

Thus, the fourth embodiment is capable of acquiring the same effect as in the first embodiment of the present invention discussed above. Moreover, the fourth embodiment is capable of reducing the calculation quantity of the power calculation process to the greater degree than in the first embodiment by obtaining the power of the two short blocks. It should be noted that the fourth embodiment is not limited to the case of using the two short blocks as the blocks for the power calculation, and the power may be calculated by employing an arbitrary number, i.e., three or more pieces of short blocks. In this case also, the same effect as the effect described above can be acquired.

[Others]

The disclosures of international application PCT/JP2004/010416 filed on Jul. 22, 2004 including the specification, drawings and abstract are incorporated herein by reference.

What is claimed is:

1. An audio encoding apparatus comprising:
a power calculation unit that calculates a power fluctuation ratio based on the input signal;
a calculation unit that calculates a prediction gain fluctuation ratio based on the input signal; and
a block length judging unit that selects one of encoding using a long block mode segmenting an input signal into frames each consisting of a predetermined number of samples and encoding each of the frames, and encoding using a short block mode segmenting each of the frames into short blocks and encoding each of the short blocks, based on the power fluctuation ratio and the prediction gain fluctuation ratio.

2. An audio encoding apparatus according to claim 1, wherein the block length judging unit selects the encoding using the short block mode if any one of the power fluctuation ratio and the prediction gain fluctuation ratio is larger than a predetermined threshold value, or selects the encoding using the long block mode.

3. An audio encoding apparatus according to claim 1, further comprising a threshold value determining unit that changes a threshold value for judging a block length used by the block length judging unit when encoding, according to the selecting result of the block length judging unit.

4. An audio encoding apparatus according to claim 3, wherein the threshold value determining unit sets the threshold value to a value larger than an initial value when the selecting result of the block length judging unit represents selection of the encoding using the short block mode.

5. An audio encoding apparatus according to claim 1, wherein the calculation unit calculates the prediction gain fluctuation ratio for a single block being combination of a predetermined number of blocks, each of which is used by the power calculation unit to calculate the power.

6. An audio encoding apparatus according to claim 1, wherein the power calculation unit calculates the power fluctuation ratio of a single block being a combination of a predetermined number of blocks, each of which is used by the calculating unit to calculate a prediction gain.

7. An audio encoding apparatus comprising:
a power calculation unit that calculates a power fluctuation ratio based on the input signal;
a calculation unit that calculates a prediction gain fluctuation ratio based on the input signal;
a block length judging unit that selects one of encoding using a long block mode segmenting an input signal into frames each consisting of a predetermined number of samples and encoding each of the frames, and encoding using a short block mode segmenting each of the frames into short blocks and encoding each of the short blocks, based on the power fluctuation ratio and the prediction gain fluctuation ratio;
a first transformunit that obtains, if the block length judging unit selects the encoding using the long block mode, a first coefficient by executing modified discrete cosine transform of the input signal with a long block unit;
a second transform unit that obtains, if the block length judging unit selects the encoding using the short block mode, a second coefficient by executing modified discrete cosine transform of the input signal with a short block unit;
a selection unit that selects one of the first coefficient and the second coefficient as a third coefficient, according to the selecting result of the block length judging unit;
a psychological auditory sense analyzing unit that obtains a masking threshold value from the input signal;
a quantization unit that obtains a first code by spectrum-quantizing the third coefficient in accordance with the masking threshold value;
a Huffman coding unit that obtains a second code by Huffman-coding the first code;
a quantization control unit that calculates, from the second code, a total number of bits consisting of a bitstream to be outputted to instruct outputting the bitstream on the basis of a result of the calculation of the total number of bits; and
a bitstream generation unit that generates the bitstream from the second code to output the bitstream on the basis of an instruction from the quantization control unit.

8. An audio encoding apparatus according to claim 7, wherein the block length judging unit selects the encoding based using the short block mode if any one of the power fluctuation ratio and the prediction gain fluctuation ratio is larger than a predetermined threshold value, or selects the encoding using the long block mode.

9. An audio encoding apparatus according to claim 7, further comprising a threshold value determining unit that changes a threshold value for judging a block length used by the block length judging unit when encoding, according to the selecting result of the block length judging unit.

10. An audio encoding apparatus according to claim 9, wherein the threshold value determining unit sets the threshold value to a value larger than an initial value when the selecting result of the block length judging unit represents selection of the encoding using the short block mode.

11. An audio encoding apparatus according to claim 7, wherein the calculation unit calculates the prediction gain fluctuation ratio for a single block being combination of a predetermined number of blocks, each of which is used by the power calculation unit to calculate the power.

12. An audio encoding apparatus according to claim 7, wherein the power calculation unit calculates the power fluctuation ratio of a single block being a combination of a predetermined number of blocks, each of which is used by the calculating unit to calculate a prediction gain.

13. An audio encoding method comprising:
a power calculation step of calculating a power fluctuation ratio based on the input signal;
a calculation step of calculating a prediction gain fluctuation ratio based on the input signal; and
a block length judging step of selecting one of encoding using a long block mode segmenting an input signal into frames each consisting of a predetermined number of samples and encoding each of the frames, and encoding using a short block mode segmenting each of the frames into short blocks and encoding each of the short blocks, based on the power fluctuation ratio and the prediction gain fluctuation ratio.

14. An audio encoding method comprising:
a power calculation step to calculate a power fluctuation ratio based on the input signal;
a calculation step to calculate a prediction gain fluctuation ratio based on the input signal;
a block length judging step to select one of encoding using a long block mode segmenting an input signal into frames each consisting of a predetermined number of samples and encoding each of the frames, and encoding using a short block mode segmenting each of the frames into short blocks and encoding each of the short blocks, based on the power fluctuation ratio and the prediction gain fluctuation ratio;
a first transform step to obtain, if the encoding using the long block mode is selected, a first coefficient by executing modified discrete cosine transform of the input signal with a long block unit;
a second transform step to obtain, if the encoding using the short block mode is selected, a second coefficient by executing modified discrete cosine transform of the input signal with a short block unit;
a selection step to select one of the first coefficient and the second coefficient as a third coefficient, according to the selecting result of the block length judging step;
a psychological auditory sense analyzing step to obtain a masking threshold value from the input signal;
a quantization step to obtain a first code by spectrum-quantizing the third coefficient in accordance with the masking threshold value;
a Huffman coding step to obtain a second code by Huffman-coding the first code;
a quantization control step to calculate, from the second code, a total number of bits consisting of a bitstream to be outputted to instruct outputting the bitstream on the basis of a result of the calculation of the total number of bits; and
a bitstream generation step to generate the bitstream from the second code to output the bitstream on the basis of an instruction outputted at the quantization control step.
